(19) United States
(12) Patent Application Publication
(10) Pub. No.: US 2005/0175749 A1
(43) Pub. Date: Aug. 11, 2005

(54) Method for making turkey bacon

(76) Inventor: David J. Gruis, Willmar, MN (US)

Correspondence Address: IPLM GROUP, P.A., POST OFFICE BOX 18455, MINNEAPOLIS, MN, 55418, US

(21) Appl. No.: 10/774,304

(22) Filed: Feb. 6, 2004

(51) Int. Cl. A23L 1/00

(52) U.S. Cl. 426/438

(57) ABSTRACT

The present invention relates to a method for making turkey bacon, and more particularly, a method for making precooked, pre-crisped, turkey bacon. In a preferred embodiment method of making ready-to-eat, fried turkey bacon, sliced turkey bacon is obtained. The turkey bacon is fried in oil, and the fried turkey bacon is crisp and has rippled edges. A flavoring solution is then applied to the fried turkey bacon. The fried and flavored turkey bacon has a flavor, an appearance, and a texture similar to pork bacon.

### BACKGROUND OF THE INVENTION

1. Field of the Invention

The present invention relates to a method for making turkey bacon, and more particularly, a method for making precooked, pre-crisped, turkey bacon.

2. Description of the Prior Art

Turkey bacon is typically made by extruding, in emulsion form, two different types of emulsions including turkey meat. One type of emulsion is darker in color than the other type of emulsion. This results in a light and dark product resembling the appearance of pork bacon. However, historically, this product differs substantially from pork bacon. For example, turkey bacon and other bacon analogs have been somewhat dry and do not have the flavor, appearance, or texture similar to pork bacon. These products tend to be more rubbery than pork bacon. Therefore, there has been reluctance to use such bacon alternatives.

Precooked pork bacon has become expensive and also has considerable variations in size and appearance. In addition, there are people who cannot eat pork for various reasons, such as health or religious reasons, and these people need a pork bacon alternative. Therefore, it is desirable to offer an alternative that more closely resembles pork bacon in flavor, appearance, and texture.

### SUMMARY OF THE INVENTION

In a preferred embodiment method of making ready-to-eat, fried turkey bacon, sliced turkey bacon is obtained. The turkey bacon is fried in oil, and the fried turkey bacon is crisp and has rippled edges. A flavoring solution is applied to the fried turkey bacon. The fried and flavored turkey bacon has a flavor, an appearance, and a texture similar to pork bacon.

In another preferred embodiment method of making precooked turkey bacon, turkey meat and fat are blended into a dark portion and a white portion. The dark portion and the white portion are extruded in a desired ratio, the desired ratio resulting in a mixture resembling pork bacon. The mixture is cooked thereby creating a product, and the product is sliced and then fried in oil. A flavoring is then applied to the fried product.

In another preferred embodiment method of making precooked turkey bacon, a dark portion and a white portion are proportioned such that the portions resemble pork bacon. The portions are cooked thereby creating a product, and the product is sliced and then fried in oil. The fried product is crisp and has rippled edges. A flavoring is applied to the fried product. The fried and flavored product has a flavor, an appearance, and a texture similar to pork bacon.

### BRIEF DESCRIPTION OF THE DRAWINGS

FIG. 1 is a flow chart of a preferred method for making turkey bacon according to the principles of the present invention.

### DETAILED DESCRIPTION OF A PREFERRED EMBODIMENT

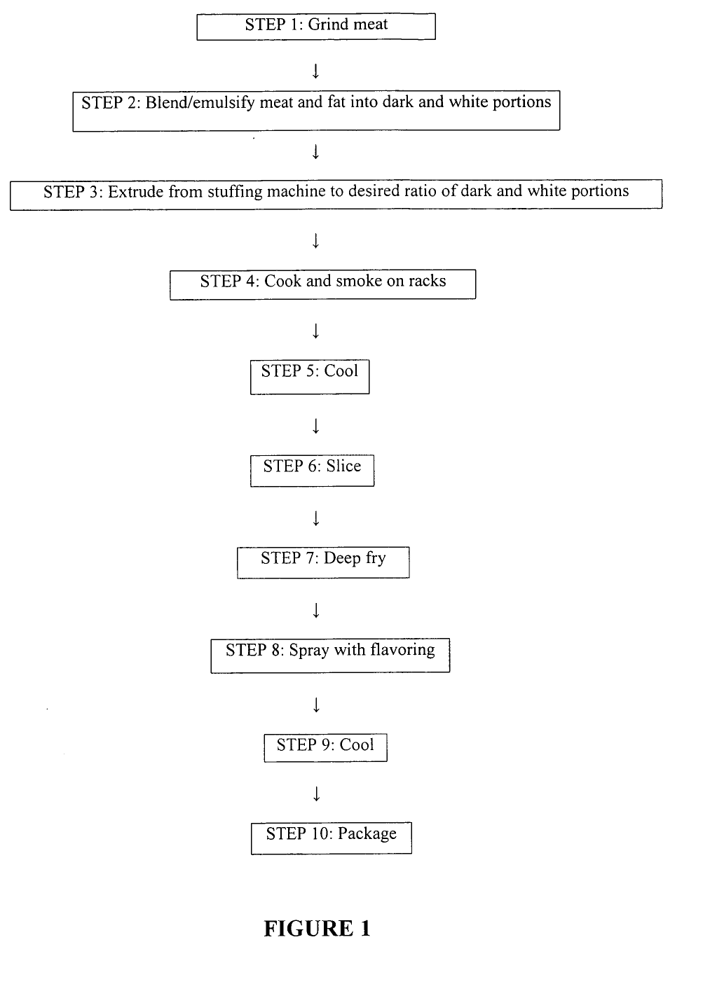

A preferred embodiment of the present invention, as depicted in the flow chart shown in FIG. 1, is a method for making precooked, pre-crisped, turkey bacon, which is essentially ready-to-eat.

The preferred meat formula for the precooked, pre-crisped, turkey bacon includes white turkey meat, mechanically de-boned turkey meat (dark turkey meat), and fat. Turkey fat is preferably used, however, it is recognized that fat or fat substitutes from any suitable source well known in the art may be used. The term fat is being used generally herein to include any such suitable types of fat or fat substitutes. Generally, the components are ground and then blended in choppers and/or blenders, and the blended meat is extruded from two separate stuffing machines to the desired ratio of appearance of dark and white portions.

During the grinding step, step 1 in FIG. 1, the white turkey meat is ground through a grinder or processed with a similar meat recovery system well known in the art. The meat should be ground enough to make an emulsion, which is accomplished with the grinder or similar meat recovery system. For the mechanically de-boned turkey meat, the turkey carcass is pumped into a mechanical de-boning device such as a Beehive Model #588 bone separator or a Yieldmaster bone separator. The meat is then chilled and pumped through a metal detector. Then, the fat content is checked. The temperature of the meat is preferably less than 40° F.

During the blending step, step 2 in FIG. 1, the dark portion and the white portion are emulsified. For the dark portion, the white turkey meat and the mechanically de-boned turkey meat are placed into a bowl chopper. Fat, ice, and salt are added and the ingredients are chopped for approximately 1 minute. The remaining dry ingredients are added and chopped for approximately 45 seconds. Enough carbon dioxide snow is added to the mixture to maintain a temperature of approximately 40° F. or less. The mixture is chopped for approximately 15 seconds. The emulsion is emptied into a stainless steel tank. The preferred percentages of the ingredients used for the dark portion are shown in Table 1. A regular formulation and a low fat formulation are shown.

TABLE 1
A Preferred Dark Portion Formulation

| | Approximate Percentage | |
|---|---|---|
| Ingredient | Regular | Low Fat |
| White Turkey Meat | 19.00-21.00 | 19.00-21.00 |
| Mechanically De-boned | 58.30-64.40 | 67.80-74.90 |
| Turkey Meat, 20% Fat | | |
| Fat | 9.50-10.50 | 0.00 |
| Ice/Water | 2.20-2.40 | 2.20-2.40 |
| Salt | 2.20-2.40 | 2.20-2.40 |
| Sodium Erythorbate | 0.05 | 0.05 |
| Sugar | 2.50 | 2.50 |
| Cure (Salt and 6.25 Sodium Nitrite) | 0.18 | 0.18 |
| Bacon Flavoring | 1.00 | 1.00 |
| Liquid Smoke | 0.25 | 0.25 |

For the white portion, the white turkey meat is placed into a bowl chopper. Fat, ice, and salt are added and the ingredients are chopped for approximately 1 minute. The remaining dry ingredients are added and chopped for approximately 2 minutes. Enough carbon dioxide snow is added to the mixture to maintain a temperature of approximately 40° F. or less. The mixture is chopped for 30 seconds or less, preferably just until the carbon dioxide snow is blended. The preferred percentages of the ingredients used for the white portion are shown in Table 2. A regular formulation and a low fat formulation are shown. The resulting portions are held overnight in a raw cooler at a temperature of less than 40° F. There is preferably a 24 hour cure time before the product is cooked.

TABLE 2
A Preferred White Portion Formulation

| | Approximate Percentage | |
|---|---|---|
| Ingredient | Regular | Low Fat |
| White Turkey Meat | 60.61-67.00 | 77.02-86.29 |
| Fat | 26.41-71.19 | 9.50-10.50 |
| Ice/Water | 2.20-2.40 | 2.20-2.40 |
| Salt | 2.20-2.40 | 2.20-2.40 |
| Sodium Erythorbate | 0.05 | 0.05 |
| Sugar | 2.37-2.62 | 2.37-2.62 |
| Cure (Salt and 6.25 Sodium Nitrite) | 0.18 | 0.18 |
| Bacon Flavoring | 1.00 | 1.00 |

In the regular formulations, the dark portion includes approximately 58.30 to 64.40% mechanically de-boned turkey meat containing over 20% fat and approximately 19.00 to 21.00% white turkey meat, and the white portion includes approximately 60.61 to 67.00% white turkey meat. In the low fat formulations, the dark portion includes approximately 67.80 to 74.90% mechanically de-boned turkey meat containing over 20% fat and approximately 19.00 to 21.00% white turkey meat, and the white portion includes approximately 77.02 to 86.29% white turkey meat.

After the dark portion and the white portion are blended, one stuffer is filled with the dark portion and another stuffer is filled with the white portion. This is step 3 in FIG. 1. Approximately 50 to 60% dark portion and 40 to 50% white portion are extruded concurrently onto a silicone paper lined cutting board. Because these portions are substantially emulsified in form, they readily form a substantially uniform slab. The silicone sheet is slid off the cutting board onto a bacon cook rack. The racks may be stored in a cooler at less than 40° F. or placed directly in an oven.

The extruded meat is then cooked and smoked on racks, step 4 in FIG. 1. A preferred cooking cycle is listed in Table 3. The bacon is preferably cooked for approximately 5 hours and step 7 should be continued until the internal meat temperature is greater than 160° F. Although the meat is preferably fully cooked, the meat must only be cooked enough to develop a firmness so that it is a sliceable product. The cooked meat is then cooled to less than 40° F., step 5 in FIG. 1.

TABLE 3
Preferred Cooking Cycle

| | Time | Dry Bulb Temp. | Wet Bulb Temp. | rH | | |
|---|---|---|---|---|---|---|
| Step | (hours) | (° F.) | (° F.) | % | Humidity | Damper |
| 1 | 1:00 | 120 | 50 | 0 | steam | auto |
| 2 | 0:30 | 140 | 50 | 0 | steam | auto |
| 3 | 0:30 | 140 | 105 | 31 | steam | auto |
| 4 | 0:30 | 150 | 120 | 41 | steam | auto |
| 5 | 1:00 | 160 | 135 | 51 | steam | auto |
| 6 | 0:30 | 170 | 150 | 60 | steam | auto |
| 7 | until done | 180 | 170 | 79 | steam | auto |

After cooling to less than 40° F., the turkey bacon slabs are transferred onto a conveyor. The slabs are then sliced, step 6 in FIG. 1. A slicer is set for preferably 18 to 23 slices per inch, and the slabs are conveyed through the slicer. The slice length is preferably approximately 5.75 to 6.50 inches. Although the slices are preferably rectangular in shape to resemble pork bacon slices, it is recognized that any shape is acceptable. Regardless of the shape and/or configuration, the turkey bacon preferably has a thickness that allows the turkey bacon to crisp and have curled or rippled edges similar to pork bacon after frying. The slices of turkey bacon are then conveyed through a hot oil frying system, step 7 in FIG. 1. Frying oil at a temperature of 335° F. is used, and the slices are deep fried for approximately 45 to 55 seconds. The dark portion should be a reddish color rather than a brownish color. The frying step removes moisture from the sliced bacon thereby crisping the bacon and gives the slices a curled or rippled edge similar to pork bacon. Prior to frying, the water activity level is preferably approximately 0.98 and after frying, the water activity level is preferably 0.65 to 0.80. During the frying step, some of the flavor may be lost. Optionally, rather than preparing slices of turkey bacon, bits of turkey bacon may be prepared by grinding the slices into bits after the frying step. The slices or bits are then conveyed through the flavoring applicator where each slice or batch of bits is sprayed with a flavoring solution, step 8 in FIG. 1. The flavoring solution may include the ingredients in the percentages shown in Table 4 for one possible flavoring solution or in Table 5 for another possible flavoring solution.

TABLE 4
Ingredients in a Flavoring Solution

| Ingredient | Percentage |
|---|---|
| Water | 37-47 |
| Sugar | 20-30 |
| Salt | 8-18 |
| Liquid Smoke | 15-25 |

TABLE 5
Ingredients in another Flavoring Solution

| Ingredient | Percentage |
|---|---|
| Water | 84.67 |
| Bacon Flavoring | 15.00 |
| Natural Flavoring | 0.33 |

Although liquid smoke is well known in the art, examples of liquid smoke that may be used are CHARSOL® LFBN, CHAROIL® B, RA 70, or CharSol Supreme Poly™ by Red Arrow Products Company LLC in Manitowoc, Wis. or Natural Smoke Flavor WONF 018-0920, 018-0610, or 018-4066 by Innova, a Griffith Laboratories Company, in Oak Brook, Ill. An example of a bacon flavoring that may be used is Flavor #613409 by Givaudan Flavors Corp. of Cincinnati, Ohio, and an example of a natural flavoring that may be used is HERBALOX™ Seasonings Product Type HT-H by Kalsec, Inc. of Kalamazoo, Mich. It is recognized that the formulation of the flavoring solution may vary as long as a flavorful, satisfactory product results. The flavoring solution is preferably added to provide a more bacon-like flavor in the final product, and there are numerous bacon-like flavors that could be used.

Approximately 2 to 3% of the finished weight is the amount of flavoring solution applied to the fried bacon. Because the frying step removes most of the flavor, this flavoring step is important in making a flavorful, satisfactory product. The finished regular product preferably includes approximately 22 to 31% protein, 35 to 50% total fat, and 15 to 19% moisture. The water activity level of the finished product is preferably 0.65 to 0.80. The slices of flavored, crisped bacon are then cooled, step 9 in FIG. 1, and packaged, step 10 in FIG. 1.

The product is preferably shelf stable and may be stored at room temperature or in a refrigerator and can be heated by consumers in a microwave, on a grill, in a frying pan, or by other suitable heating methods. For example, if a microwave is used, four slices are preferably placed on a single layer of paper towel and heated in the microwave on high for 20 seconds. If an oven is used, the rack should be placed in the center of the oven and the oven should be preheated to 350° F. In a conventional oven, sixteen slices are preferably placed on a cookie sheet and baked for approximately 3.5 minutes. In a convection oven, sixteen slices are preferably placed on a cookie sheet and baked for approximately 1.5 minutes. If a flat grill is used, the grill should be preheated to 350° F. and then the bacon is cooked for approximately 1 minute, flipping the bacon after 30 seconds. If a stove is used, a frying pan is warmed over medium heat (without oil) and bacon is placed in a single layer in the frying pan. The bacon is cooked for approximately 30 to 45 seconds and then flipped for an additional 30 to 45 seconds. These examples are not exhaustive, and it is recognized that other suitable heating methods may be used. Once the package has been opened, the product should be stored in a refrigerator.

In sum, the turkey bacon is formulated to a specific white to dark ratio, fat content, and flavor profile. Nutritional advantages may also be available by adjusting the fat to lean portions of the formulation, as shown in Tables 1 and 2. The formulations are extruded onto a cooking surface and heat processed. The cooked and cooled slabs of turkey bacon are sliced to a specific thickness and transferred into an oil fryer for the final cooking. The frying removes a specific amount of moisture from the slices. During this part of the process the turkey bacon slices tend to curl as in fried pork bacon, which adds to the pork-like appearance. This part of the process also delivers a more crisp texture to the turkey bacon than pan frying. Upon leaving the oil fryer a solution is sprayed onto the slices to enhance the flavor. This solution is a specific combination of ingredients and imparts a pork bacon like flavor and aroma. The individual slices are then cooled and packaged. Optionally, rather than preparing slices of turkey bacon, bits of turkey bacon may be prepared by grinding the slices into bits after the frying step.

### EXAMPLE 1

White turkey meat obtained from turkey wings was ground through a grinder enough to make an emulsion, and a turkey carcass was pumped into a Beehive Model #588 bone separator to obtain dark turkey meat. The meat was then chilled so that the temperature of the meat was approximately 38° F. The meat was pumped through a metal detector, and then the fat content was checked to ensure the meat contained 20% fat.

A dark portion and a white portion were each blended in a bowl chopper for approximately 2 minutes after all of the ingredients for each were added. The preferred formulation for the dark portion is listed in Table 6, and the preferred formulation for the white portion is listed in Table 7. Approximately 50% of each portion was extruded concurrently onto a silicone paper lined cutting board, transferred onto a bacon cook rack, and then cooked using the preferred cooking cycle in Table 3.

TABLE 6
Dark Portion Formulation

| Ingredient | Pounds | Percentage |
|---|---|---|
| Sodium Nitrite Cure (6.25%) | 0.90 | 0.18 |
| Vegetarian Smoke Bacon | 5.00 | 1.00 |
| CHARSOL ® LFBN | 1.25 | 0.25 |
| Aro-Smoke 8056 | 1.25 | 0.25 |
| High Grade Salt | 11.75 | 2.35 |
| Sodium Erythorbate | 0.25 | 0.05 |
| Sugar | 12.50 | 2.50 |
| Mechanically De-boned Turkey Meat, over 20% Fat | 306.80 | 61.36 |
| White Turkey Meat | 100.00 | 20.00 |
| Water | 10.50 | 2.10 |
| Rendered Turkey Fat | 50.00 | 10.00 |

TABLE 7
White Portion Formulation

| Ingredient | Pounds | Percentage |
|---|---|---|
| Sodium Nitrite Cure 6.25% | 0.90 | 0.18 |
| Vegetarian Smoke Bacon | 5.00 | 1.00 |
| High Grade Salt | 11.75 | 2.35 |
| Sodium Erythorbate | 0.25 | 0.05 |
| Sugar | 12.50 | 2.50 |
| Water | 11.60 | 2.32 |
| Rendered Turkey Fat | 139.00 | 27.80 |
| White Turkey Meat | 319.05 | 63.81 |

After cooking, the meat was cooled to approximately 36° F. and then transferred onto a conveyor for slicing. The slabs were sliced with a slicer set for 23 slices per inch. The slices were then conveyed through a hot oil frying system. The frying oil was at a temperature of approximately 335° F., and the slices were fried for approximately 50 seconds. Prior to frying, the moisture level was 58% and after frying, the water activity level was 0.65 to 0.75. The slices were then conveyed through the flavoring applicator where each slice was sprayed with approximately 3% of the preferred flavoring solution listed in Table 8.

TABLE 8
Flavoring Solution

| Ingredient | Percentage |
|---|---|
| Water | 84.67 |
| Bacon Flavoring | 15.00 |
| Natural Flavoring | 0.33 |

The bacon flavoring used was Flavor #613409 by Givaudan Flavors Corp. of Cincinnati, Ohio, and the natural flavoring used was HERBALOX™ Seasonings Product Type HT-H by Kalsec, Inc. of Kalamazoo, Mich. The finished product included approximately 18.8% protein, 40% total fat, and 17% moisture. The water activity level of the finished product was 0.65 to 0.75. The flavored slices were then cooled to 40° F. and packaged.

The above specification, examples and data provide a complete description of the manufacture and use of the composition of the invention. Since many embodiments of the invention can be made without departing from the spirit and scope of the invention, the invention resides in the claims hereinafter appended.

1. A method of making ready-to-eat, fried turkey bacon, comprising:
a) obtaining sliced turkey bacon;
b) frying the turkey bacon in oil, the fried turkey bacon being crisp and having rippled edges; and
c) applying a flavoring solution to the fried turkey bacon, the fried and flavored turkey bacon having a flavor, an appearance, and a texture similar to pork bacon.

2. The method of claim 1, further comprising cooling the fried turkey bacon to less than 40° F.

3. The method of claim 2, further comprising reheating the cooled, fried turkey bacon.

4. The method of claim 1, the turkey bacon being fried in oil at approximately 335° F. for approximately 45 to 55 seconds.

5. The method of claim 1, wherein approximately 2 to 3% of a finished weight of the fried turkey bacon of flavoring solution is applied to the fried turkey bacon.

6. The method of claim 1, the flavoring solution comprising salt and liquid smoke.

7. The method of claim 1, further comprising prior to step 1(a):
a) extruding a dark portion and a white portion in a desired ratio resulting in a mixture resembling pork bacon;
b) cooking the mixture to an internal temperature of at least 160° F. thereby creating a product; and
c) slicing the product to create sliced turkey bacon.

8. The method of claim 7, further comprising prior to step 8(a):
a) grinding turkey meat; and
b) blending turkey meat and fat into the dark portion and the white portion.

9. The method of claim 1, further comprising grinding the fried turkey bacon into bits.

10. A method of making precooked turkey bacon, comprising:
a) blending turkey meat and fat into a dark portion and a white portion;
b) extruding the dark portion and the white portion in a desired ratio, the desired ratio resulting in a mixture resembling pork bacon;
c) cooking the mixture thereby creating a product;
d) slicing the product;
e) frying the product in oil; and
f) applying a flavoring to the fried product.

11. The method of claim 10, further comprising proportioning approximately 50 to 60% dark portion and approximately 40 to 50% white portion during the extruding step.

12. The method of claim 10, the mixture being cooked to an internal temperature of at least 160° F. thereby creating the product.

13. The method of claim 10, the product being sliced approximately 18 to 23 slices per inch in thickness.

14. The method of claim 13, the product being sliced approximately 5.75 to 6.50 inches in length.

15. The method of claim 10, the product being fried in oil at approximately 335° F. for approximately 45 to 55 seconds.

16. The method of claim 10, wherein approximately 2 to 3% of a finished weight of the fried product of flavoring is applied to the fried product.

17. A method of making precooked turkey bacon, comprising:
a) proportioning a dark portion and a white portion such that the portions resemble pork bacon;
b) cooking the portions thereby creating a product;
c) slicing the product;
d) frying the product in oil, the fried product being crisp and having rippled edges; and
e) applying a flavoring to the fried product, the fried and flavored product having a flavor, an appearance, and a texture similar to pork bacon.

18. The method of claim 17, the product being fried in oil at approximately 335° F. for approximately 45 to 55 seconds.

19. The method of claim 17, further comprising grinding the fried product into bits.

20. The method of claim 17, wherein approximately 2 to 3% of a finished weight of the fried product of flavoring is applied to the fried product.
